(19) United States
(12) Patent Application Publication
(10) Pub. No.: US 2009/0052104 A1
(43) Pub. Date: Feb. 26, 2009

(54) Energy Store System

(76) Inventors: Peter Birke, Glienicke/Nordbahn (DE); Axel Rudorff, Berlin (DE); Michael Keller, Baden-Baden (DE)

Correspondence Address: CONTINENTAL TEVES, INC., ONE CONTINENTAL DRIVE, AUBURN HILLLS, MI, 48326-1581, US

(21) Appl. No.: 12/282,561

(22) PCT Filed: Feb. 21, 2007
(86) PCT No.: PCT/DE2007/000325

§ 371 Date: Sep. 11, 2008

(30) Foreign Application Priority Data
Mar. 20, 2006 (DE) 10 2006 013 135.5

(51) Int. Cl. H02H 7/18

(52) U.S. Cl. 361/93.9; 903/907

(57) ABSTRACT

An energy storage system (10) with an energy storage unit (8) to which a short-circuit fuse element is assigned, is designed to enable an increase in operational safety in a hybrid motor vehicle. For this purpose, it is provided according to the invention that the short-circuit fuse element is electrically connected in series with a current restricting component.

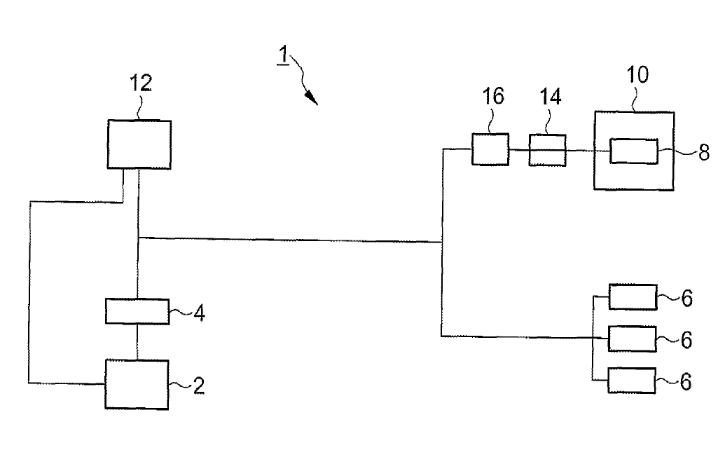

### BACKGROUND OF THE INVENTION

The invention relates to an energy storage system with an energy storage unit.

The combination of different drive principles or different energy sources for one drive task within an application is known as a hybrid drive of a motor vehicle. A differentiation is made between different hybridisation systems, such as micro hybrid, with which a start-stop operation is made possible, wherein for this purpose, the hybrid system works with the existing on-board network. In the micro hybrid system, the internal combustion engine can be switched off when the motor vehicle is at a standstill, and re-started without any noticeable time delay when the vehicle starts moving again. This enables significant fuel savings, for example when the hybrid vehicle is used in typical urban stop-and-go traffic.

The hybrid system may further be embodied as a mild hybrid, when an alternative drive form is used solely to support the main drive form. A full hybrid is the embodiment of a hybrid system with which the drive forms available are capable of acting autonomously. A further extension of the hybrid system is realised in the form of a “power hybrid”.

A version of the hybrid motor vehicle is realised as a combination of an internal combustion engine and one or more electric motor(s). The internal combustion engine can be operated to a very high degree of efficiency with the hybrid drive. Any excess energy which is produced is used to electrically charge the battery via a generator. When the same acceleration is achieved, therefore, a smaller internal combustion engine can be provided. The reduction in size of the internal combustion engine here partially compensates for the additional weight of the hybrid aggregates.

A hybrid motor vehicle generally comprises an energy storage unit. The energy from this energy storage unit can be used to start the internal combustion engine, for the electric consumers in the motor vehicle and for driving.

When braking and in coasting mode, part of the braking energy is fed back into the battery, a process referred to as recuperation. This recovery contributes towards a reduction in consumption, in particular in urban traffic and when driving downhill. A further advantage of this design is that no conventional starting engine is required, since the electric motor can perform this function.

An internal combustion engine provides a high torque in an upper engine speed range. By contrast, the electric motor already provides the maximum torque when the vehicle starts to move, and reduces the torque at a higher motor speed. By combining the two engines, the torque progressions can advantageously supplement each other, and with current designs, the motor vehicle can accelerate approximately 10% to 30% faster.

The operation of the internal combustion engine in a more favourable range of operation leads to lower emissions. This applies both to toxic emissions and to the release of the greenhouse gas CO₂ as a direct result of the lower fuel consumption.

Several versions of the design of a motor vehicle with a hybrid drive and the combination of an internal combustion engine with one or more electric motor(s) are possible. In one possible version, the hybrid motor vehicle has a petrol engine and an electric motor, which are coupled via a planetary gear set to the drive axis. Operating states in which the internal combustion engine only has a low degree of efficiency, for example when the vehicle starts to move or in urban traffic, are adopted by the electric motor with a far greater degree of efficiency. When required, the internal combustion engine can also be completely switched off. When driving with a constant load, the petrol engine drives the motor vehicle alone, while the energy storage unit is simultaneously charged by the petrol engine via the generator. With a heavier load, the motor vehicle is driven by both engines together. Energy can be recuperated in engine brake mode. The energy savings as opposed to petrol-driven motor vehicles of the same class are up to 30%, depending on the driving cycle. A version with a recharging option on the mains supply and a greater electrical range has to date only been realised as a prototype (plug-in hybrid).

In another design, for example in order to increase driving performance over difficult terrain, the drive of the hybrid motor vehicle comprises, alongside the petrol engine, two electric motors, with one each on the front and on the rear axle. The overall power of a model of this type can total over 300 kW according to the current design, wherein the force distribution is for example designed in such a manner that the petrol engine contributes 47% to the overall power, the electric motor for which the drive acts on the front axle contributes 38%, and the electric motor which is connected to the rear axle contributes 15%. However, the engine powers cannot be added together, since the battery can only deliver a restricted level of power.

A further design of the drive system provides that the electric motor does not rest on an axle, but is coupled to a drive chain between the motor and the gears. As a result, significantly less technology is required as opposed to the embodiments described above, which in turn leads to lower power requirements.

In order to enable the electric machine to perform a function as an electric drive, it must draw the electrical energy required in order for it to do so from an energy storage unit. The energy storage unit must be constantly charged for this purpose. The unit is charged via what is known as recuperation in braking and coasting mode, or via the energy delivered by the internal combustion engine, wherein high current levels occur.

The object of the invention is to provide an energy storage system of the type described above which contributes to an increase in operational safety in a hybrid vehicle.

### SUMMARY OF THE INVENTION

This object is attained according to the invention by assigning a short-circuit fuse element to the energy storage unit which is electrically connected in series with a current restricting component.

The invention is based on the consideration that by using a high-energy storage unit in an energy storage system of a hybrid motor vehicle, short-circuit currents of several thousand amperes may occur as a result of an error. For example, lithium ion cells which are already in use reach short-circuit current levels of 2,500 amperes.

Safety measures to protect the energy storage unit and the user of the motor vehicle are advantageous and desirable in view of this performance density. However, fuses for this area of application are predominantly designed for a short-circuit current of up to 2,000 amperes. This restriction also applies to other utilisable components in an energy storage system such as contactors or connectors.

Experience has shown that contactors can become stuck or flutter when high currents such as short-circuit currents occur.

Since the short-circuit currents are higher than the maximum level with which fuses and the other components described can cope, an option needs to be found for restricting these currents to the maximum level which can be processed.

In order to restrict the current which occurs during a short-circuit to a specified level using a measure which is simple to calculate and which is cost-effective, a resistor is advantageously provided as a current restricting component.

In order to be able to realise the circuit arrangement in the most simple and cost-effective manner possible, and to avoid having to incorporate any additional components, the current feed cables of the energy storage unit advantageously have a specified set resistance which corresponds to the design of the overall system.

Should the energy storage unit be designed as a serial connection of a number of battery cells, the electric cell connectors are advantageously designed as a current restricting component with a specified set resistance which is determined by the design, in order to avoid the incorporation of additional components into the serial connection and thus to avoid any possible additional sources of error and increased costs.

In order to avoid an increase in the resistance of the current restricting component as a result of the probable heating of the current restricting element by flowing currents, an occurrence which is determined by the design, and to enable said resistance to maintain a specified value which is determined by the design, the current restricting component advantageously has a corresponding, non-linear resistance characteristic curve over the temperature.

In order not to restrict the flowing currents of the on-board network in normal, non-erroneous operation, but rather to restrict only the short-circuit current in the case of a short-circuit due to a defect, an inductor is advantageously provided as a current restricting component.

The advantages achieved with the invention are in particular that the operational safety of the hybrid motor vehicle is significantly increased due to the fact that as a result of the combination of a passive and a current restricting component, a fuse for example is reliably triggered. For this purpose, the current must be maintained within a range above a specified level which represents the threshold level for the triggering of the fuse. Furthermore, due to the lower maximum level of the short-circuit currents, more advantageously dimensioned and lower cost components can be used in the energy storage system.

An exemplary embodiment of the invention will now be described in greater detail with reference to a drawing.

### BRIEF DESCRIPTION OF THE DRAWING

The FIGURE therein shows a schematic view of the flow from the generator to the energy storage unit.

### DETAILED DESCRIPTION OF THE DRAWING

The on-board network 1 of a motor vehicle generally shows the following flow: the internal combustion engine 2 in a motor vehicle of the standard type, i.e. the embodiment with only an internal combustion engine 2, drives a generator 4 which is typically designed as a so-called dynamo. This dynamo supplies the electric energy for the entire on-board network. This includes a number of consumers 6.

Furthermore, the electric energy which is not required for operating the motor vehicle and the associated consumers 6 is fed into the energy storage unit 8 of the energy storage system 10 for later use.

In the particular embodiment of the motor vehicle as a hybrid vehicle with an internal combustion engine 2 and an electric motor 12, the use of a separate generator, for example of the dynamo, can be avoided, since the electric motor 12 adopts this function. In this embodiment, the energy storage unit 8 of the energy storage system 10 is designed with a particularly high capacity in order to store the necessary electric energy for the operation of the hybrid vehicle with the electric motor 12, and to keep it available for use.

Generally, the electric energy is guided from the energy storage system 10 via a fuse 14, so that short-circuit currents, for example, are prevented from reaching the on-board network 1 and/or the consumers 6.

Instead of a fuse 14, a combination of a fuse and a contactor can be used. However, a contactor is operated at a low ohmic level, as a result of which the restriction of any short-circuit current which may occur is highly important. Should a higher current flow to the contactor, the result may be fluttering and, in an unfortunate case, a sticking of the contactor.

A resistor 16 is inserted into the current feed between the fuse 14 and the energy storage system 10 with the energy storage unit 8, which effectively restricts any short-circuit current which may occur, so that the fuse provided is reliably triggered. Here, the resistor 16 functions as a current restricting component.

Instead of the resistor 16, an inductor can be incorporated into the current circuit at this point in the flow of the on-board network 1, i.e. in a serial connection with the fuse 14, since this inductor absorbs only the peak of a short-circuit current; otherwise, however, it does not restrict the flowing currents as an ohmic resistor 16 would.

Since a short-circuit current, which can reach up to 2,000 amperes, and even more in particular cases which are determined by the design, generally only occurs in a time interval of a few hundredths of a second, it is sufficient in order to maintain operational safety of the hybrid motor vehicle that only the aforementioned peaks of the short-circuit currents are avoided so that the inductor is designed solely for the prevention of the damaging short-circuit current.

1-6. (canceled)

7. An energy storage system (10) comprising:
an energy storage unit (8) having a short-circuit fuse element is assigned, wherein the short-circuit fuse element is electrically connected in series with a current restricting component.

8. An energy storage system (10) according to claim 7, wherein a resistor (16) is provided as a current restricting component.

9. An energy storage system (10) according to claim 7, wherein a number of current feed cables of the energy storage unit (8) are provided as a current restricting component, and have a specified set resistance which is determined by the design.

10. An energy storage system (10) according to claim 7, wherein the energy storage unit (8) comprises a serial connection of a number of battery cells which are mechanically and electrically connected via cell connectors, wherein the cell connectors are provided as a current restricting component, and have a specified inner resistance which is determined by the design.

11. An energy storage system (10) according to claim 7, wherein the current restricting component has a non-linear resistance characteristic curve over temperature.

12. An energy storage system (10) according to claim 7, wherein an inductor is provided as a current restricting component.

13. An energy storage system (10) according to claim 7, wherein the energy storage unit is provided in a hybrid motor vehicle.
